(19) United States
(12) Patent Application Publication
(10) Pub. No.: US 2023/0140116 A1
(43) Pub. Date: May 4, 2023

(54) WIRELESS CHARGING SYSTEM

(71) Applicant: Rosen Aviation, LLC, Eugene, OR (US)

(72) Inventor: Darrell Ray Finneman, Albany, OR (US)

(73) Assignee: Rosen Aviation, LLC, Eugene, OR (US)

(21) Appl. No.: 17/969,413

(22) Filed: Oct. 19, 2022

Related U.S. Application Data
(60) Provisional application No. 63/275,365, filed on Nov. 3, 2021.

(51) Int. Cl. H02J 50/12; H02J 50/00; H02J 7/00; H02J 50/90

(52) U.S. Cl. CPC H02J 50/12; H02J 50/005; H02J 7/00034; H02J 50/90

(57) ABSTRACT

An inductive charging device includes a housing having a compartment and a charging plate covering the compartment, the charging plate having an inner surface and an outer surface. The inductive charging device has a transmitting coil disposed within the compartment. The transmitting coil can be configured to receive an electrical current and generate a magnetic field from the electrical current. The transmitting coil can be configured to move along the inner surface of the charging plate to align with a receiving coil of an electronic device placed on the outer surface of the charging plate. The transmitting coil can be configured to pivot about at least one axis when moving along a curved portion of the inner surface.

### CROSS-REFERENCE TO RELATED APPLICATION

This application claims the benefit of U.S. Provisional Application No. 63/275,365, filed Nov. 3, 2021, which is incorporated by reference herein.

### FIELD

The present disclosure generally concerns wireless charging, and more particularly is related to devices and methods for wirelessly charging an electronic device using a movable transmitting coil.

### BACKGROUND

Wireless charging uses electromagnetic induction to wirelessly transmit power between a charging device and another electronic device (e.g., smartphones, smart watches, electric toothbrushes, remote controllers, etc.) that can be wirelessly charged. Typically, the charging device has a primary coil (also referred to as “transmitting coil”) and the to-be-charged electronic device has a secondary coil (also referred to as a “receiving coil”). The charging device can generate an electrical current which creates an electromagnetic field around the transmitting coil. When the receiving coil of the electronic device is placed in close proximity with the transmitting coil, the electromagnetic field can induce a current in the receiving coil, which can be used to charge a battery electrically coupled to the receiving coil. Alignment between the receiving coil and the transmitting coil can affect the efficiency of wireless charging. As such, misplacement of the electronic device relative to the charging device can reduce the efficiency of wireless charging. This problem can occur when the electronic device is placed in a position on a charging surface of the charging device that is offset from the transmitting coil. Thus, room for improvements exists for proper alignment between the transmitting coil of the charging device and the receiving coil of the electronic device.

### SUMMARY

The present disclosure relates to devices and methods for wirelessly charging an electronic device.

Certain examples of the disclosure concern an inductive charging device. The inductive charging device can include a housing having a compartment and a charging plate covering the compartment. The charging plate can have an inner surface and an outer surface. The inductive charging device can also include a transmitting coil disposed within the compartment. The transmitting coil can be configured to receive an electrical current and generate a magnetic field from the electrical current. The transmitting coil can be configured to move along the inner surface of the charging plate to align with a receiving coil of an electronic device placed on the outer surface of the charging plate. The transmitting coil can be configured to pivot about at least one axis when moving along a curved portion of the inner surface.

According to certain examples, an inductive charging device can include a cover, a floor, a chamber enclosed between the cover and the floor, an arm having a head portion and a base portion, a transmitting coil received in the head portion and configured to contact or keep a predefined distance from an inner surface of the cover, a sensor configured to detect an electronic device placed on an outer surface of the cover, and an actuator configured to move the base portion on the floor in two dimensions so as to align the transmitting coil with the electronic device. The transmitting coil can be configured to receive an electrical current and generate a magnetic field from the electrical current. At least one portion of the cover can be not parallel to the floor such that the chamber has an uneven height measured between the cover and the floor. The arm can be configured to dynamically adjust a vertical distance between the head portion and the base portion to conform to the height of the chamber and maintain contact or keep the predefined distance between the transmitting coil and the inner surface of the cover during movement of the base portion.

According to certain examples, an inductive charging device can include a housing having a cover and a floor, an arm extending between the cover and the floor, a transmitting coil received in a head portion of the arm, and an actuator configured to move a base portion of the arm on the floor so that the transmitting coil is aligned with an electronic device placed on top of the cover. The transmitting coil can be configured to receive an electrical current and generate a magnetic field from the electrical current. The transmitting coil can maintain contact with or keep a predefined distance from the cover when moving the base portion of the arm on the floor. At least a portion of the cover can be curved.

Certain examples of the disclosure also concern a method of wirelessly charging an electronic device placed on a curved surface. The method can include detecting a position of the electronic device placed over the curved surface, moving a transmitting coil underneath the curved surface until the transmitting coil is aligned with a receiving coil of the electronic device, and generating an electrical current in the transmitting coil so as to establish an electromagnetic coupling between the transmitting coil and the receiving coil. Moving the transmitting coil can include rotating the transmitting coil about at least one axis so that the transmitting coil conforms to a curvature of the curved surface.

According to certain examples, an inductive charging device can include a housing having a compartment and a charging plate covering the compartment, and the charging plate can have an inner surface and an outer surface. The inductive charging device can also include a transmitting coil disposed within the compartment, a sensor configured to detect a first location of an electronic device placed on the outer surface of the charging plate, and an actuator configured to move the transmitting coil within the compartment so that the transmitting coil is located in a first position on the inner surface of the charging plate, wherein the first position on the inner surface can be aligned with the first location of the electronic device. The sensor can be configured to detect the electronic device if it moves from the first location to a second location on the outer surface of the charging plate. Responsive to detecting the electronic device moves from the first location to the second location, the actuator can be configured to move the transmitting coil from the first position to a second position on the inner surface of the charging plate, wherein the second position on the inner surface can be aligned with the second location of the electronic device.

According to certain examples, a method of wirelessly charging an electronic device can include detecting a first location of the electronic device placed over a charging surface, moving a transmitting coil underneath the charging surface until the transmitting coil is moved to a first position aligned with the first location of the electronic device, detecting the electronic device as it moves from the first location to a second location over the charging surface, and responsive to detecting movement of the electronic device, moving the transmitting coil underneath the charging surface to a second position aligned with the second location of the electronic device.

The foregoing and other objects, features, and advantages of the invention will become more apparent from the following detailed description, which proceeds with reference to the accompanying figures.

### BRIEF DESCRIPTION OF THE DRAWINGS

FIG. 1 is an overall block diagram depicting an example wireless charging system comprising a charging device and an electronic device to be charged.

FIG. 2 is a flowchart illustrating an example overall method of wirelessly charging an electronic device placed over a curved surface.

FIG. 3 is a flowchart illustrating an example overall method of wirelessly charging an electronic device based on dynamic tracking a location of the electronic device.

FIG. 4 is a cross-sectional view of a charging device having a flexible arm, according to one example.

FIG. 5 is a cross-sectional view of a charging device having a flexible arm, according to another example.

FIG. 6 is a block diagram depicting a wireless charging device having multiple chambers and transmitting coils, according to one example.

FIG. 7 is a block diagram of an example computing system in which described technologies can be implemented.

### DETAILED DESCRIPTION

### Overview of Inductive Charging

Described herein are examples of improved inductive charging devices (also referred to as “inductive chargers”) and methods of wirelessly charging an electronic device. Although the inductive charging devices described below have specific structural components, it should be understood that alternative structures can be employed based on the same principle disclosed herein.

Further, it is to be understood that the to-be-charged electronic device described herein can be any device and equipment having a receiving coil capable of inductive coupling and a rechargeable battery coupled to the receiving coil. In certain examples, such electronic device can be a portable gadget, such as a smartphone, a smart watch, an electric toothbrush, a game console, a remote controller, etc. To wirelessly charge the portable gadget, the inductive charging device can be a standalone charging apparatus, or embedded into other objects such as tables, consoles, chairs, or the like. In particular examples, the inductive charging device can be integrated within an interior component of a vehicle, such as a center console, a vehicle seat, a countertop, a foldable table, an interior wall/panel/frame, etc. As described herein, the vehicle can be an automobile, a boat, a trailer, a helicopter, an airplane, or any other transportation apparatus. In other examples, the to-be-charged electronic device can be a large object such as a battery-powered equipment, an electric bike, an electric vehicle, etc. To wirelessly charge such a large object, the inductive charging device can be a charging station configured to receive the large object.

Inductive charging is a type of wireless power transfer. An inductive charger can use electromagnetic induction to provide electricity to another electronic device. One common inductive charging standard is the Qi standard, which is an open interface standard that defines wireless power transfer using inductive charging over distances of up to several centimeters and is typically used for wirelessly charging portable gadgets. In operation, alternating current passes through a transmitting coil of the inductive charger and creates a fluctuating magnetic field. Through inductive coupling, a receiving coil in the electronic device can pick up the fluctuating magnetic field and generate an induced alternative current, which can be rectified to a direct current for charging a battery of the electronic device.

The efficiency of inductive charging decreases when the receiving coil of the electronic device is not aligned properly with the transmitting coil of the inductive charger. Typically, both the transmitting coil and the receiving coil can be configured as planar spiral coil inductors. As described herein, proper alignment between the transmitting coil and the receiving coil refers to a condition that the receiving coil and the transmitting coil are oriented parallel to each other and that they are so positioned as to overlap with each other.

Generally, when the transmitting coil is aligned with the electronic device (e.g., placing the electronic device immediately above or underneath the transmitting coil), there is also substantial alignment between the transmitting coil and the receiving coil inside the electronic device, especially when the surface area of the electronic device is comparable or smaller than the surface area of the transmitting coil. Thus, in any of the examples described herein, when describing the alignment of the transmitting coil, “aligned with the receiving coil,” “aligned with the electronic device,” and “aligned with a location of the electronic device” are used interchangeably.

Misalignment can happen if the electronic device is placed over a charging surface of the inductive charger but a location of the receiving coil is offset from the transmitting coil. Even if initially the receiving coil of the electronic device is perfectly aligned with the transmitting coil of the inductive charger, misalignment between the receiving coil and the transmitting coil can occur during the charging period when the electronic device is accidentally moved. For example, assume an inductive charger is placed inside a vehicle and a smartphone is placed over a charging surface of the inductive charger for wireless charging. Sudden acceleration and/or deceleration of the vehicle can cause the smartphone to move on the charging surface, causing misalignment between the smartphone's receiving coil and the inductive charger's transmitting coil even if they were initially aligned perfectly.

In another scenario, the charging surface of the inductive charger may not be planar. For example, when embedding the inductive charger in a host object (e.g., an armrest of a seat, a foldable table, etc.), a top surface of the host object can be used as a charging surface for an electronic device. However, because of cosmetic concerns and/or other functional reasons, the top surface of the host object may have sloped and/or curved portions. In certain cases, it may not be desirable and/or feasible to mark a location on the charging surface to indicate an ideal charging position. As a result, a user may place the electronic device in any portion of the non-planar charging surface, including the sloped and/or curved portions. Additionally, the electronic device may move from a planar portion to the sloped and/or curved portion during the charging, as described above. Such a non-planar charging surface can pose additional challenges for properly aligning the electronic device's receiving coil with the inductive charger's transmitting coil.

The technologies described here, by incorporating a movable transmitting coil in an inductive charging device, can overcome many of the challenges described above.

### Overview of an Example Wireless Charging System

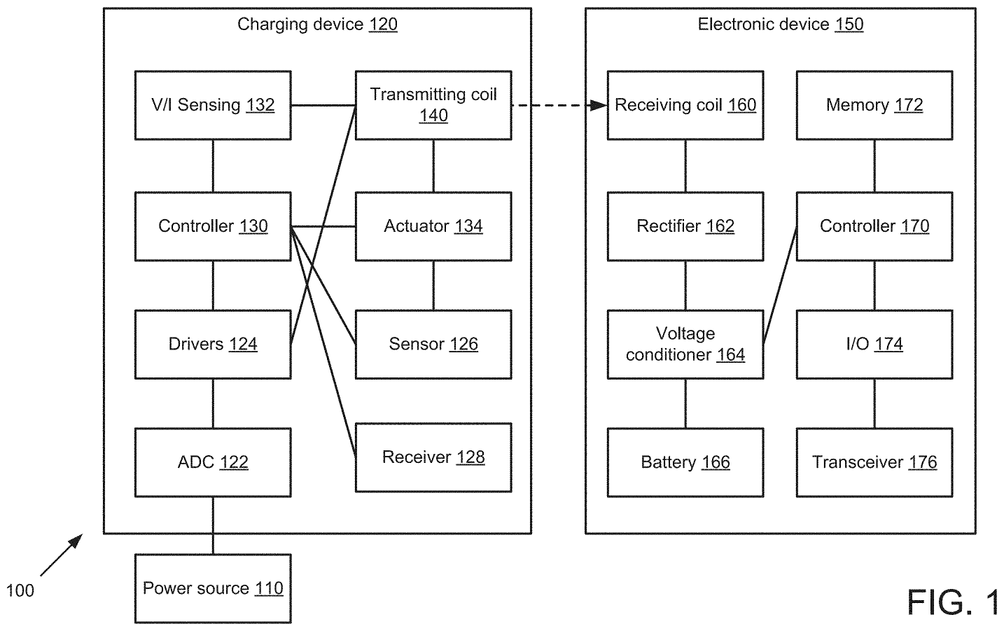

FIG. 1 depicts an overall block diagram depicting an example wireless charging system 100 comprising a charging device 120 and an electronic device 150 to be charged.

As shown, the charging device 120 can be powered by a power source 110. Although the power source 110 is shown to be external to the charging device 120, it is to be understood that in lieu of or in addition of the external power source 110, the charging device 120 can have an internal power source, such as a rechargeable battery.

In the depicted example, the charging device 120 includes an AC-DC power conversion (ADC) unit 122, one or more drivers 124, and a controller 130. The ADC unit 122 can convert AC current provided by the power source 110 to DC current, which is amplified by the drivers 124 under the control of the controller 130. The charging device 120 includes at last one transmitting coil 140, which receives the amplified current from the drivers 124. The charging device 120 can also include a voltage/current (V/I) sensing unit 132 configured to measure the voltage and/or current across the transmitting coil 140, and feedback such measurement to the controller 130 for modulating/adjusting the output of the drivers 124.

As described herein, the charging device 120 can include at least one sensor 126 configured to detect a location of the electronic device 150. The charging device 120 can further include an actuator 134 configured to move the transmitting coil 140 to a location that is properly aligned with the electronic device 150. In certain examples, the actuator 134 can include an arm being connected to the transmitting coil 140. In certain examples, the actuator 134 can include at least one motor configured to move the arm so as to cause movement of the transmitting coil 140. As described more fully below, the actuator 134 can be configured to enable the transmitting coil 140 to translate in three dimensions and rotate in one or more axes so as to enable the transmitting coil 140 to follow complex surface shapes (e.g., a curved surface as described more fully below).

In certain examples, the charging device 120 can further include a receiver 128 configured to receive information from other devices. For example, the receiver 128 can be configured to receive a battery status of the electronic device 150 and/or other information, such as travel duration data from a moving vehicle in which the charging device 120 is located. Based on the information received by the receiver 128, the controller 130 can selectively turning on or off, or modulate the electrical current to the transmitting coil 140. In certain examples, the sensor 126 can be a part of, or integrated with the receiver 128 (i.e., the sensor 126 and the receiver 128 can be a unitary device). In certain examples, the receiver 128 and/or the sensor 126 can be a transceiver (i.e., a combination of transmitter/receiver) configured to both send information to and receive information from other devices.

In certain examples, operations of the sensor 126, actuator 134, and the receiver 128 can be controlled by the controller 130. For example, the controller 130 can include one or more microprocessors coupled with memory and/or input/output (I/O) interfaces through buses to form a computing system, as described further below.

As shown, the electronic device 150 includes at least one receiving coil 160. When the receiving coil 160 is placed in close proximity to the transmitting coil 140, a significant portion of the magnetic field generated by the transmitting coil 140 can be inductively coupled to the receiving coil 160, generating an induced current.

The electronic device 150 can also include a rectifier 162 configured to convert the induced current from AC to DC. In addition, the electronic device 150 can include a voltage conditioner 164 and a controller 170. Under the control of the controller 170, the voltage conditioner 164 can be configured to improve the quality of the power (e.g., noise suppression, transient impulse protection, etc.) delivered to the load, which is depicted as a rechargeable battery 166 in this example. In other words, the conditioned DC current can be used to charge the battery 166.

In the depicted example, the controller 170 can include one or more microprocessors coupled with memory 172 and I/O interfaces 174 to form a computing system. For example, when the electronic device 150 is a mobile computing device (e.g., a smartphone), the controller 170 can be a microprocessor embedded in the mobile computing device.

In certain examples, the electronic device 150 can further include a transceiver 176 configured to establish and perform wireless communication with other devices through one or more communication protocols, such as Bluetooth, Bluetooth Low-Energy, Wi-Fi, Radio-frequency identification (RFID), etc. In one example, the transceiver 176 can establish bidirectional communication with the sensor 126 of the charging device 120 so that the sensor 126 can detect the location of the electronic device 150, e.g., based on decay of a signal transmitted by the transceiver 176 and received by the sensor 126, based on time-of-flight of a signal transmitting between the transceiver 176 and the sensor 126, or any other means. In another example, the transceiver 176 can establish bidirectional communication with the receiver 128 of the charging device 120 so that the receiver 128 can receive the status of the battery 166.

In certain examples, when a wireless link is established between the charging device 120 and the electronic device 150 (e.g., via Bluetooth pairing, or the like), the electronic device 150 can be configured to actuate a haptic actuator (e.g., a vibrator) or other types of actuators to notify a user the establishment of the linkage. In certain examples, the electronic device 150 can also be configured to detect the location of the charging device 120.

In certain examples, the wireless charging system 100 can be integrated within a vehicle such as an aircraft. A user can install a software application on the electronic device 150 (e.g., a smartphone) which controls various cabin management functions offered by the vehicle and allows a user to enter and/or select certain parameters related to the cabin management functions (e.g., user's preferences on the cabin's entertainment system, the lighting around the user's seat, a target capacity for wireless charging, etc.). Activation of such software application can register the user's electronic device 150 with the vehicle's central management system (e.g., the flight management system of an aircraft), which can detect where the user is sitting, what electronic device 150 the user is using, and automatically links the user's electronic device 150 to the charging device 120 assigned to (or located near) the user's seat in the vehicle. The charging device 120 can be configured to detect the electronic device's proximity (e.g., by using Wi-Fi, Bluetooth, Bluetooth LE, RFID, cell data, etc.) to the charging surface and send a command to activate the haptic actuator of the electronic device 150. For example, the charging device 120 can send a Wi-Fi radio signal which can be received by the electronic device 150 to establish a wireless communication link. Through the application running on the electronic device 150, location of the electronic device 150 can be monitored. When the electronic device 150 is in close proximity to the charging device 120, the haptic actuator of the electronic device 150 can be activated, notifying the user that the electronic device 150 is ready to be charged. In certain examples, the charging of the electronic device 150 is triggered after detecting the electronic device is placed on a charging surface of the charging device 120. Then, the charging device 120 can move the transmitting coil 140 to the desired location (i.e., aligned with the electronic device 150) and automatically initiates wireless charging.

The system 100 and any of the other systems described herein can be implemented in conjunction with any of the hardware components described herein, such as the computing systems described below (e.g., processing units, memory, and the like). In any of the examples herein, the battery status, the sensor data, and the like can be stored in one or more computer-readable storage media or computer-readable storage devices. The technologies described herein can be generic to the specifics of operating systems or hardware and can be applied in any variety of environments to take advantage of the described features.

### Example Overall Method of Inductively Charging Electronic Device

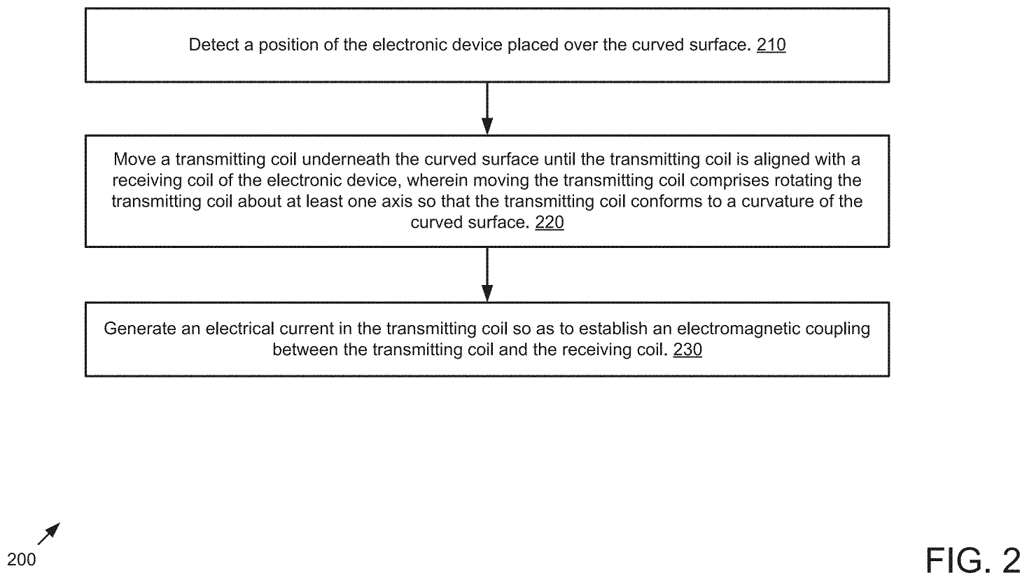

FIG. 2 is a flowchart depicting an example overall method 200 of inductively charging an electronic device (e.g., 150) placed over a curved surface, and can be performed, for example, by the charging device 120.

At 210, the method 200 can detect a position of the electronic device placed over the curved surface. Such detection can be performed, for example, by a sensor (e.g., 126) embedded in the charging device which can establish a wireless communication with a transceiver (e.g., 176) of the electronic device.

At 220, the method 200 can move a transmitting coil (e.g., 140) of the charging device underneath the curved surface until the transmitting coil is aligned with a receiving coil (e.g., 160) of the electronic device. Moving the transmitting coil can include rotating the transmitting coil about at least one axis so that the transmitting coil conforms to a curvature of the curved surface. Similarly, detecting that the transmitting coil is moved to a location aligned with the receiving coil can be performed based on the measurement of the sensor (e.g., 126).

Then at 230, the method 200 can generate an electrical current in the transmitting coil (e.g., via the ADC 122, drivers 124, and controller 130) so as to establish an electromagnetic coupling between the transmitting coil and the receiving coil.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

### Example Method of Dynamic Tracking Electronic Device During Inductive Charging

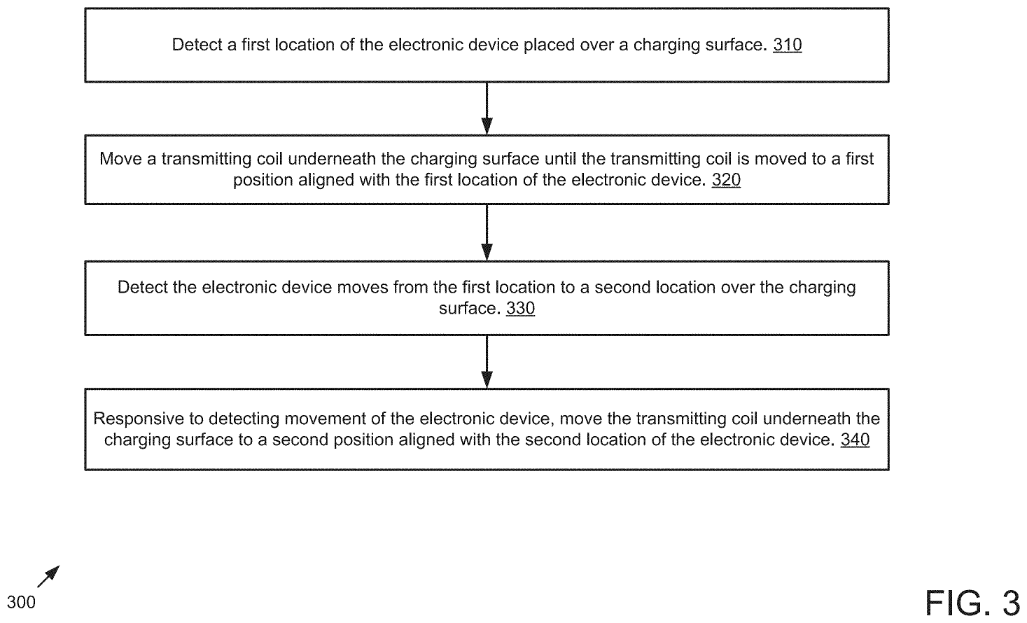

FIG. 3 is a flowchart depicting an example overall method 300 of inductively charging an electronic device (e.g., 150) based on dynamic tracking a location of the electronic device, for exampling, using the charging device 120. As described herein, the location of the electronic device can approximate the location of the receiving coil inside the electronic device.

At 310, the method 300 can detect a first location of the electronic device placed over a charging surface. Similarly, such detection can be performed, for example, by a sensor (e.g., 126) embedded in the charging device. Different methods can be used for the detection. For example, the charging device can detect the electronic device using Bluetooth or Bluetooth Low Energy (e.g., if the discovery mode is enabled), over Wi-Fi network, through the cell signal, etc. As noted above, in certain cases, establishment of the link between the charging device and the electronic device can actuate a haptic actuator of the electronic device.

At 320, the method 300 can move a transmitting coil (e.g., 140) underneath the charging surface until the transmitting coil is moved to a first position aligned with the first location of the electronic device. Similarly, confirming that the transmitting coil is moved to a location aligned with the electronic device can be performed based on the sensor measurement.

At 330, the method 300 can detect the electronic device moves from the first location to a second location over the charging surface 330. Movement of the electronic device can be caused by a variety of reasons. For example, a user may accidentally move the electronic device. In another example, the user may accidentally shake the charging device that causes the movement of the electronic device. In yet another example, when the charging device is placed inside a vehicle, sudden acceleration and/or deceleration of the vehicle can cause the electronic device to move relative to the charging device. Likewise, detecting the movement of the electronic device can be performed by the sensor embedded in the charging device.

Then at 340, responsive to detecting movement of the electronic device, the method 300 can move the transmitting coil underneath the charging surface to a second position aligned with the second location of the electronic device the method 300. In other words, the charging device can track the movement of the electronic device over the charging surface in real-time and dynamically adjust the location of the transmitting coil so that the transmitting coil remains aligned with the electronic device.

### Example Inductive Charging Device Having a Movable Transmitting Coil

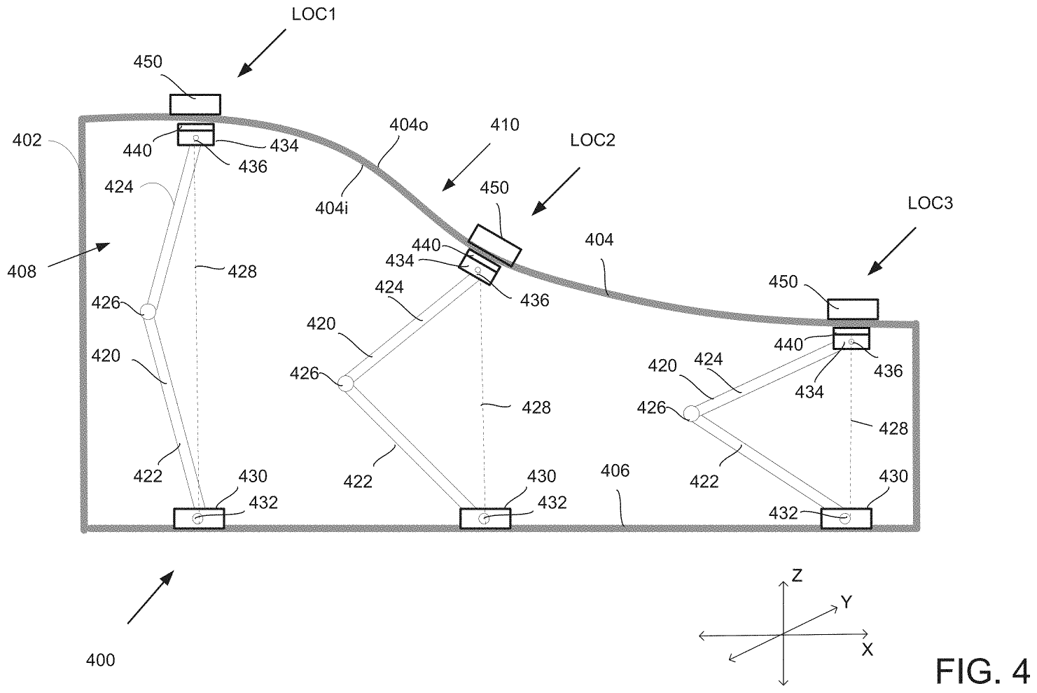

FIG. 4 depicts the cross-sectional view (cutting across the X-Z plane in a three-dimensional space spanned by X, Y, and Z axes) of a charging device 400, according to one example.

As shown, the charging device 400 includes a housing 402. The housing 402 can be a standalone object or an object embedded inside another article (e.g., a chair, a table, a console, or the like). The housing 402 can include a cover 404, which can also be referred to as a charging plate. In addition, the housing 402 can have a floor 406 and a chamber 408 (also referred to as a “compartment”) enclosed between the cover 404 and the floor 406.

The cover 404 can have an outer surface 404o and an inner surface 404i. An electronic device 450 can be placed on the cover 404, i.e., over the outer surface 404o, for charging. The outer surface 404o can also be referred to as the charging surface. In certain examples, the cover 404 can have a generally uniform thickness. In other examples, different portions of the cover 404 can have different thicknesses. The thickness of the cover 404 can be smaller than a predefined value (e.g., less than 3 cm, 2 cm, 1 cm, 0.5 cm, or the like) so as to ensure electromagnetic coupling for inductive charging of the electronic device.

As shown, at least a portion 410 of the cover 404 can have a curved shape. In the depicted example, the curved portion 410 has a curved outer surface 404o and a matching curved inner surface 404i. In other examples, the curved portion 410 can have non-matching outer surface 404o and inner surface 404i. For example, the cover 404 can have a curved outer portion and a relatively flat inner portion on the opposite side of the curved outer portion. As another example, the cover 404 can have a relatively flat outer portion and a curved inner portion on the opposite side of the relatively flat outer portion. In yet a further example, the cover 404 can have a curved outer portion and a curved inner portion on the opposite side of the curved outer portion, but the curved outer portion and the curved inner portion can have different curvatures. Although in the depicted examples, the curved portion 410 has a curved outer portion and a matching curved inner portion, it should be understood that the same principles described herein can also be applied to a cover having a curved portion with non-matching outer surface and inner surface.

In the depicted example, the floor 406 is generally flat. Thus, the curved portion 410 of the cover is not parallel to the floor 406, resulting in an uneven height (measured between the cover 404 and the floor 406) of the chamber 408. In other examples, the floor 406 can also be non-planar (e.g., sloped and/or curved). The same principled described herein can also be applied to a charging device having a non-planar floor.

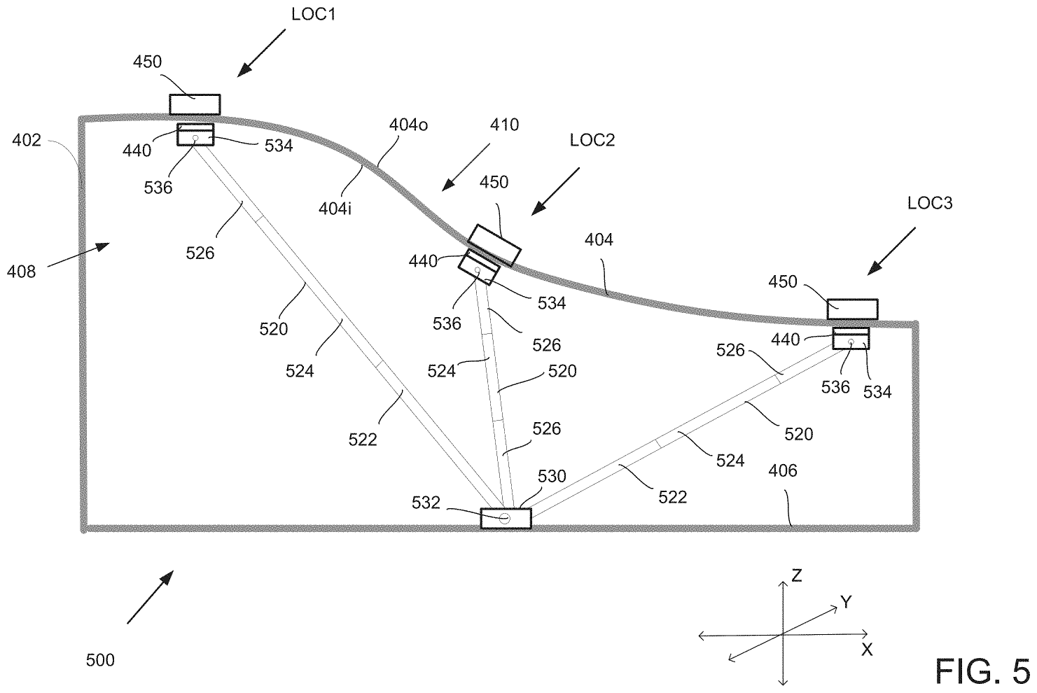

The charging device 400 includes a transmitting coil 440 disposed within the chamber 408. The transmitting coil 440 can be configured to receive an electrical current and generate a magnetic field from the electrical current. As described above, the charging device 400 can include a sensor configured to detect a location of the electronic device 450 and an actuator configured to move the transmitting coil 440 to a location that is properly aligned with a receiving coil of the electronic device 450. In certain examples, the actuator can include a flexible arm (as described further below) coupled to the transmitting coil 440. In certain examples, the actuator can include at least one motor configured to move the flexible arm and/or the transmitting coil 440 in three dimensions. In FIGS. 4-5, the sensor configured to detect the location of the electronic device 450 and the motor configured to actuate movement of the flexible arm are omitted from the figures for simplicity.

Referring to FIG. 4, the transmitting coil 440 can be configured to move along the inner surface 404i of the cover 404 to align with a receiving coil of the electronic device 450 placed on the outer surface 404o of the cover 404. Further, the transmitting coil 440 can be configured to pivot about at least one axis when moving along a curved portion of the inner surface (e.g., the curved inner portion at 410) so that the transmitting coil 440 can remain contact with or a predefined distance from the inner surface 404i during the movement. As described herein, the transmitting coil 440 does not need to return to a home position when no electronic device is detected for charging.

For example, FIG. 4 shows that the electronic device 450 can be positioned in different locations, such as LOC1, LOC2, and LOC3, on the outer surface 404o of the cover 404. In the depicted example, LOC1 and LOC3 correspond to relatively flat portions of the cover 404, and LOC2 corresponds to the curved portion 410. When detecting movement of the electronic device 450 (e.g., between LOC1 and LOC2, and/or between LOC2 and LOC3), the transmitting coil 440 can be configured to move along a trace on the inner surface 404i so that the transmitting coil 440 can track the location of the electronic device 450. When moving across the curved portion 410, the transmitting coil 440 can pivot about one or more axes so that it can remain substantially coplanar with or parallel to the inner surface 440i (e.g., the planar surface of the transmitting coil 440 can overlap or is parallel to a substantially planar patch on the curved portion 410, assuming the curved portion 410 can be modeled by a mesh of substantially planar patches), thereby maintaining proper alignment with the electronic device 450.

Example Flexible Arm with a Movable Base Portion

As shown in FIG. 4, the charging device 400 can include a flexible arm 420 having a head portion 434 and a base portion 430. The transmitting coil 440 can be received in the head portion 434. In certain examples, the transmitting coil 440 can be configured to contact the inner surface 404i of the cover 404. The head portion 434 can be of any shape and/or size so long as it can securely retain the transmitting coil 440. The transmitting coil 440 can be coupled to the head portion 434 in any means, e.g., via fastening, clasping, gluing, welding, etc. In certain examples, the head portion 434 can be external to or not a part of the flexible arm 420. For example, in certain cases, the head portion 434 can be a holder of the transmitting coil 440 and can be removably mounted to the flexible arm 420.

In other examples, the transmitting coil 440 can be configured to keep within a predefined distance from the inner surface 404i of the cover 404. The predefine distance can be less than 1 cm, e.g., about 5 mm, about 4 mm, about 3 mm, about 2 mm, about 1 mm, etc. In such circumstances, the head portion 434 can be configured to remain contact with the inner surface 404i during movement of the flexible arm 420 so that the head portion 434 can pivot about an axis (e.g., pivot about a hinge 436) when moving across a curved portion of the inner surface 404i. The transmitting coil 440 can be configured to be non-rotatable relative to the head portion 434. Thus, pivoting of the head portion 434 can cause corresponding pivoting of the transmitting coil 440. As a result, when the head portion 434 overlaps a portion of the inner surface 404i, the transmitting coil 440 is also parallel to the portion of the inner surface 404i.

Thus, the transmitting coil 440 and/or the head portion 434 can move along the inner surface 404i in a contact manner (e.g., the transmitting coil 440 and/or the head portion 434 can maintain contact with the inner surface 404i during movement of the flexible arm 420) or a contactless manner (e.g., the transmitting coil 440 and/or the head portion 434 can keep a predefined distance from the inner surface 404i during movement of the flexible arm 420).

The base portion 430 of the arm 420 can be attached to the floor 406 of the housing 402. In the depicted example, the base portion 430 is movable in two dimensions (e.g., the X-Y plane) on the floor 406 and can track the position of the electronic device 450. For example, when the electronic device 450 moves from LOC1 to LOC2 and further to LOC3, the base portion 430 can also move from the left to the middle and then to the right of the chamber 408, as depicted in FIG. 4. Movement of the base portion 430 can be actuated by a motor, controlled by a controller (e.g., 130).

In the depicted example, a line 428 can remain substantially perpendicular to the floor 406 (i.e., the angle between 406 and 428 can be about 90 degrees) when moving the base portion 430. In other examples, the line 428 extending between the head portion 434 and the base portion 430 may form an oblique angle (e.g., between 45 degrees and 90 degrees) relative to the floor 406 when moving the base portion 430.

As shown in FIG. 4, the arm 420 can be configured to dynamically adjust a vertical distance between the head portion 434 and the base portion 430 to conform to the varying height of the chamber 408 and maintain contact or the predefined distance between the transmitting coil 440 and the inner surface 404i of the cover 404 during movement of the base portion 430. As a result, movement of the base portion 430 can cause the transmitting coil 440 to move along the inner surface 404i. Because the base portion 430 can track the position of the electronic device 450, the transmitting coil 440 can also track and align with the electronic device 450 (e.g., the transmitting coil 440 can be moved to a location beneath the electronic device 450).

In certain examples, the arm 420 can include two or more shafts that are hingedly connected to each other. For example, FIG. 4 shows that the arm 420 includes a lower shaft 422 and an upper shaft 424 connected by a hinge 426, which allows the two shafts 422, 424 to pivot relative to one another. In addition, the lower shaft 422 can be connected to the base portion 430 via a hinge 432, and the upper shaft 424 can be connected to the head portion 434 via a hinge 436. In certain examples, the base portion 430 can be a part of the lower shaft 422. In that case, the lower shaft 422 can be pivotably connected to the floor 406 via the hinge 432. In certain examples, the head portion 434 can be a part of the upper shaft 424. In that case, the upper shaft 424 can be pivotably connected to the head portion 434 via the hinge 436. Although two shafts 422, 424 are shown in FIG. 4, it should be understood that the arm 420 can include three or more shafts that are hingedly connected to each other in series.

As shown in FIG. 4, because the base portion 430 can move in X and Y dimensions and the chamber 408 has a varying height (e.g., due to the curved cover 404), the transmitting coil 440 can translate in all three dimensions (e.g., X, Y, and Z) within the chamber 408.

Depending on the curvature of the inner surface 404i, the transmitting coil 440 can be configured to rotate about one or more axes when moving along the inner surface 404i. For example, the cover 404 depicted in FIG. 4 has a curved cross-section along the X axis. When moving across the curved portion 410, the transmitting coil 440 can pivot about the Y axis passing through the hinge 436. Similarly, the transmitting coil 440 can pivot about the X axis and/or Z axis depending on the curvature of the curved portion traveled by the transmitting coil 440. In other words, the transmitting coil 440 can rotate about three axes within the chamber 408.

Notably, rotation of the transmitting coil 440 can be passive in that the transmitting coil 440 can rotate freely as it moves along the inner surface 404i without the need of a driver (e.g., a motor) to actively drive the rotation of the transmitting coil 440. In other words, as the transmitting coil 440 moves along the inner surface 404i, the curvature of the inner surface 404i can cause the transmitting coil 440 to rotate and adjust its orientation so that the transmitting coil 440 can remain contact with or keep the predefined distance from the inner surface 440i when following the curvature of the inner surface 440i.

Example Flexible Arm with a Fixed Base Portion

FIG. 5 depicts the cross-sectional view (cutting across the X-Z plane in a three-dimensional space spanned by X, Y, and Z axes) of another charging device 500, according to one example. In the depicted example, the charging device 500 is about the same as the charging device 400 except that the charging device 500 includes a flexible arm 520 that is different from the arm 420.

As shown, the arm 520 has a head portion 534 and a base portion 530. The transmitting coil 440 can be received in the head portion 534. In certain examples, the transmitting coil 440 can contact the inner surface 404i of the cover 404. The head portion 534 can be of any shape and/or size so long as it can securely retain the transmitting coil 440. The transmitting coil 440 can be coupled to the head portion 534 in any means, e.g., via fastening, clasping, gluing, welding, etc. In certain examples, the head portion 534 can be external to or not a part of the flexible arm 520. For example, in certain cases, the head portion 534 can be a holder of the transmitting coil 440 and can be removably mounted to the flexible arm 520.

In other examples, the transmitting coil 440 can be configured to keep within a predefined distance from the inner surface 404i of the cover 404. The predefine distance can be less than 1 cm, e.g., about 5 mm, about 4 mm, about 3 mm, about 2 mm, about 1 mm, etc. In such circumstances, the head portion 534 can be configured to remain contact with the inner surface 404i during movement of the flexible arm 520 so that the head portion 534 can pivot about an axis (e.g., pivot about a hinge 536) when moving across a curved portion of the inner surface 404i. The transmitting coil 440 can be configured to be non-rotatable relative to the head portion 534. Thus, pivoting of the head portion 534 can cause corresponding pivoting of the transmitting coil 440. As a result, when the head portion 534 overlaps a portion of the inner surface 404i, the transmitting coil 440 is also parallel to the portion of the inner surface 404i.

Thus, the transmitting coil 440 and/or the head portion 534 can move along the inner surface 404i in a contact manner (e.g., the transmitting coil 440 and/or the head portion 534 can maintain contact with the inner surface 404i during movement of the flexible arm 520) or a contactless manner (e.g., the transmitting coil 440 and/or the head portion 534 can keep a predefined distance from the inner surface 404i during movement of the flexible arm 520).

Unlike the arm 420 which has a movable base portion 430, the base portion 530 of the arm 520 can be fixedly attached to the floor 406. Also, instead of having multiple shafts that are hingedly connected to each other, the arm 520 has a plurality of telescopic shafts, e.g., 522, 524, 526. In other words, the shafts 522, 524, 526 can be coaxially arranged so that two or more of the shafts 522, 524, 526 can be axially slidable relative to each other.

In the depicted example, a lowest shaft 522 can be connected to the base portion 530 via a hinge 532, and an upper-most shaft 526 can be pivotably connected to the head portion 534 via a hinge 536. In certain examples, the base portion 530 can be a part of the lowest shaft 522. In that case, the lowest shaft 522 can be pivotably connected to the floor 406 via the hinge 532. In certain examples, the head portion 534 can be a part of the upper-most shaft 526. In that case, the upper-most shaft 526 can be pivotably connected to the transmitting coil 440 via the hinge 536. The arm 520 is flexible because the axial length of the arm 520, measured from the base portion 530 to the head portion 534, can vary based on relative sliding movement of the shafts 522, 524, 526. Although three shafts 522, 524, 526 are shown in FIG. 5, it should be understood that the arm 520 can have two or more than three telescopic shafts.

Although the base portion 530 is fixedly attached to the floor 406, the head portion 534 can track the position of the electronic device 450. This can be achieved, for example, by rotating and telescoping the flexible arm 520. For example, when the electronic device 450 moves from LOC1 to LOC2 and further to LOC3, the flexible arm 520 can rotate and telescope accordingly so that the head portion 534 (and the transmitting coil 440) is always located beneath the electronic device 450. Rotation of the flexible arm 520 can be actuated by a motor, controlled by a controller (e.g., 130).

With regard to the telescoping feature, the axial length of the flexible arm 520 can be dynamically adjusted based on the curvature of the cover 404 so that the transmitting coil 440 can move along and remain contact with or keep the predefined distance from the inner surface 404i during rotation of the flexible arm 520. This can be achieved, for example, by applying an extension force directed from the base portion 530 to the head portion 534 that urges one or more shafts (e.g., 522, 524, 526) such as with a spring to slide toward the cover 404, thereby extending the axial length of the flexible arm 520. In another example, a linear actuator can be used to change the length of the flexible arm 520, e.g., by linearly extending and/or retracting the one or more shafts (e.g., 522, 524, 526).

For example, when the flexible arm 520 rotates in a direction with a decreasing distance between the base portion 530 and the electronic device 450 (e.g., from LOC1 to LOC2, or from LOC3 to LOC2), the inner surface 404i can urge against the transmitting coil 440 and the head portion 534 and counter the extension force. In other words, a portion of the rotation force can be converted to an axial force in opposite direction relative to the extension force and urge one or more shafts to slide toward the floor 406, thereby reducing the axial length of the flexible arm 520.

Conversely, when the flexible arm 520 rotates in a direction with an increasing distance between the base portion 530 and the electronic device 450 (e.g., from LOC2 to LOC1 or LOC3), the extension force can urge one or more shafts to slide toward the cover 404 until the transmitting coil 440 contacts or reaches the predefined distance from the inner surface 404i, thereby extending the axial length of the flexible arm 520.

As a result, rotation of the flexible arm 520 can cause the transmitting coil 440 to move along the inner surface 404i and dynamically track the position of the electronic device 450, as depicted in FIG. 5.

Similar to the example depicted in FIG. 4, the transmitting coil 440 of the charging device 500 can also rotate about one or more axes (e.g., in three dimensions) when moving along the inner surface 404i. For example, the cover 404 depicted in FIG. 4 has a curved cross-section along the X axis. Likewise, rotation of the transmitting coil 440 of the charging device 500 can be passive. That is, as the transmitting coil 440 moves along the inner surface 404i due to the rotation of the flexible arm 520, the curvature of the inner surface 404i can cause the transmitting coil 440 to rotate and adjust its orientation so that the transmitting coil 440 can remain contact with or keep the predefined distance from the inner surface 440i when following the curvature of the inner surface 440i.

Alternatively, the flexible arm 520 can be constructed as a singular structure without multiple telescoping shafts. The axial length of the flexible arm 520 can be dynamically adjusted by other means. As an example, the flexible arm 520 can include a coiled spring (or similar type of a biased structure) that is movable between a biased state (e.g., axially compressed) and an unbiased state (e.g., axially relaxed). In the unbiased state, the flexible arm 520 can have a relatively long axial length that is larger than the distance from the base portion 530 to any point on the inner surface 404i. Thus, when constrained in the chamber 408, the flexible arm 520 can be in a biased state and radially compressed between the head portion 534 and the base portion 530. As the flexible arm 520 rotates (e.g., to track the position of the electronic device 450), the transmitting coil 440 can press against the inner surface 404i. The varying curvature of the inner surface 404i can apply a varying compression force against the flexible arm 520, thereby changing its axial length while maintaining contact or the predefined distance between the transmitting coil 440 and the inner surface 404i.

### Example Interface Between Transmitting Coil and Cover

For both the charging devices 400 and 500, the interface between the transmitting coil 440 and the inner surface 404i of the cover 404 can be electronically controlled to ensure the transmitting coil 440 and/or the head portion (e.g., 434, 534) can move along the inner surface 404i smoothly.

In certain examples, a distance sensor (e.g., a time-of-flight sensor, or the like) can be embedded in the transmitting coil 440 or the head portion (e.g., 434, 534). The distance sensor can be configured to measure a proximity of the transmitting coil 440 relative to the inner surface 404i. Based on the proximity measurement of the distance sensor, movement of the flexible arm (e.g., 420, 520) can be actuated and/or adjusted to ensure the transmitting coil 440 maintains contact with or keep a predefined distance from the inner surface 404i.

In certain examples, a pressure sensor can be embedded in the transmitting coil 440 if the transmitting coil 440 is configured to maintain contact with the inner surface 404i during movement of the flexible arm (e.g., 420, 520). Alternatively, a pressure sensor can be embedded in the head portion (e.g., 434, 534) if the transmitting coil 440 is configured to keep a predefined distance from the inner surface 404i while the head portion is configured to maintain contact with the inner surface 404i during movement of the flexible arm. Such pressure sensor can be configured to measure a force or pressure applied to the transmitting coil 440 or the head portion (e.g., 434, 534) by the contacting inner surface 404i. Based on the measurement from the pressure sensor, movement of the flexible arm (e.g., 420, 520) can be adjusted so that the measured force or pressure remains substantially constant or stable, and the buzz, squeak, and rattle (BSR) caused by the contact interface can be reduced.

In certain examples, a damping device can be incorporated to the transmitting coil 440 and/or the head portion (e.g., 434, 534) to further reduce the BSR. For example, the transmitting coil 440 and/or the head portion (e.g., 434, 534) can have a rubberized perimeter gasket which is configured to maintain contact with the inner surface 404i. In certain examples, a lubricant can be added to the contact interface improve the smoothness of the movement of the transmitting coil 440 and/or the head portion (e.g., 434, 534) along the inner surface 404.

Example Charging Device with Multiple Transmitting Coils

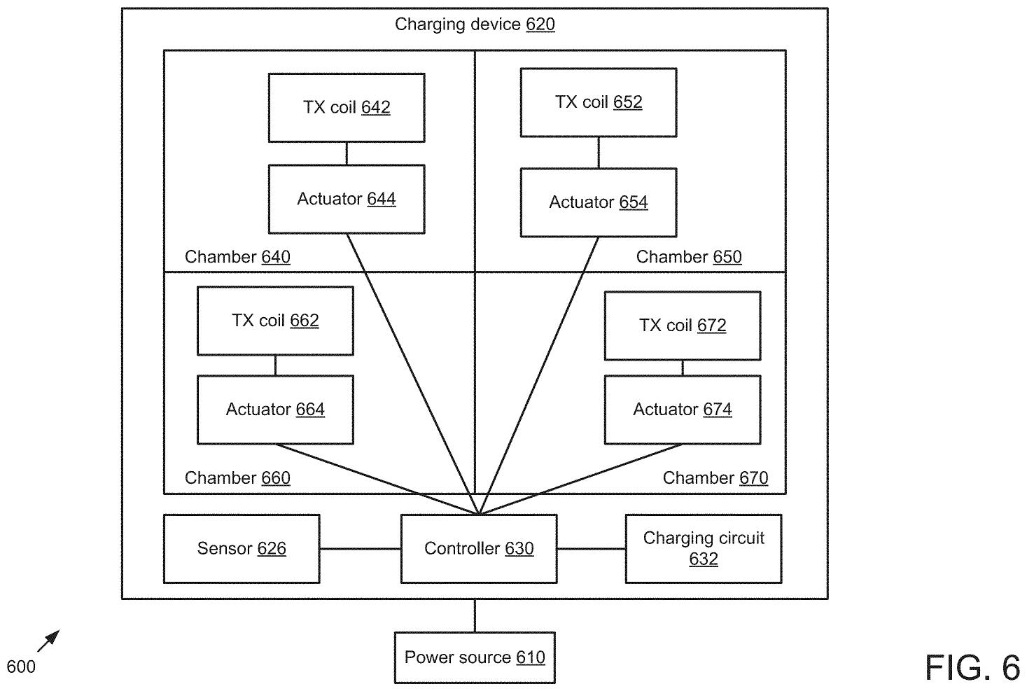

FIG. 6 is a block diagram depicting a wireless charging device 620 having multiple chambers and transmitting coils, according to one example.

In the depicted example, the charging device 620 can have a compartment divided into four chambers 640, 650, 660, 670. In other examples, the charging device 620 can have 2, 3, or more than 4 chambers. The size of the chambers can be the same or different. The distribution of the chambers within the charging device 620 can be symmetric or asymmetric.

Each of the chambers (e.g., 640, 650, 660, 670) can have a corresponding transmitting coil (e.g., 642, 652, 662, 672) and a corresponding actuator (e.g., 644, 654, 664, 674) configured to move the transmitting coil. Each actuator can have a flexible arm similar to 420 and 520, and its activation can be controlled by a controller 630 (similar to 130). Thus, each transmitting coil can be configured to move along the inner surface of a cover of the charging device 620 within the respective chamber, in a similar way as described above. Each chamber, including the transmitting coil and actuator located therein, can form a charging module that can operate independently of other charging modules.

The charging device 620 can include a charging circuit 632, which can include an ADC unit (e.g., 122), one or more drivers (e.g., 124), and a voltage/current sensing unit (e.g., 132). The charging device 620 can also include a sensor 626 (similar to 126) configured to detect a location of an electronic device to be charged.

Thus, multiple charging modules can be supported by the same controller 630, sensor 626, and charging circuit 632. In addition, the charging device 620 can have a single power source 610, which can be external or internal to the charging device 620. In other words, multiple charging modules can be grouped together and share the same power source 610. By grouping multiple charging modules, each of which has its own charging plate (or cover), a larger charging surface can be achieved.

In certain examples, when the sensor 626 detects an electronic device placed over a cover of the charging device 620, the controller 630 can determine which chamber is located underneath the electronic device. Then the actuator located in that chamber can be activated (e.g., by the controller 630) to move the corresponding transmitting coil in that chamber to align with the electronic device, based on the same principles described above.

As described herein, the charging device 620 can be used to simultaneously charge multiple electronic devices using a single power source 610. In the depicted example, four electronic devices can be simultaneously charged by placing them in four different quadrants of the charging plate respectively located above the four chambers (640, 650, 660, 670). The actuators (644, 654, 664, 674) can be activated to move the corresponding transmitting coils (642, 652, 662, 672) so that they can align with the respectively electronic devices.

In alternative embodiments, the charging device 620 can have multiple transmitting coils (e.g., 642, 652, 662, 672) located in one single chamber (e.g., the chambers 640, 650, 660, 670 can be lumped together to form a large compartment without separating walls). Each transmitting coil can be moved by a corresponding actuator (e.g., 644, 654, 664, 674) or by a single actuator (e.g., the single actuator can be configured to selectively connect to and move each of the transmitting coils). Such a charging device can also be used to simultaneously charge multiple electronic devices by aligning the transmitting coils with respective electronic devices.

For example, when detecting a first electronic device placed over the charging plate (or cover) of the charging device 620, a transmitting coil located closest to the first electronic device can be moved until it aligns with the first electronic device and starts inductive charging of the first electronic device. When detecting a second electronic device placed over the charging plate of the charging device 620, a transmitting coil located closest to the second electronic device can be moved until it aligns with the second electronic device and starts inductive charging of the second electronic device. Movement of other transmitting coils for alignment with additional electronic devices can be similarly performed.

In some examples, when determining which transmitting coil is located closest to an electronic device, only “idle” transmitting coils are evaluated. In other words, the transmitting coils that have already aligned with respective electronic devices (and started charging) will not be moved again. In other examples, when determining which transmitting coil is located closest to an electronic device, all transmitting coils are evaluated. In such case, a transmitting coil previously aligned with an electronic device may be moved again to align with another electronic device. In other words, the transmitting coils can be reallocated for alignment with electronic devices based on measured distances between the transmitting coils and electronic devices. A cost function (e g , minimizing the total movement distance of all transmitting coils, or the like) can be used to determine which transmitting coil(s) need to be moved when detecting a new electronic device placed on the charging plate.

### Example Method of Feedback Control of Inductive Charging

In any of the examples described herein, a charging device (e.g., 120, 400, 500, 620) can include a receiver (e.g., 128) configured to receive information from other devices and use that information for feedback control of inductive charging.

For example, the receiver can be configured to receive a battery status of an electronic device that is being charged. Upon detecting that the battery capacity of the electronic device is above a target capacity, such as a predetermined percentage (e.g., 80%, 85%, 90%, 95%, 100%, etc.) of the full capacity, the charging device can be configured to turn off the charging circuit. Alternatively, the charging device can be configured to reduce the electrical current fed to the transmitting coil or only turn on the charging circuit as needed to maintain the battery capacity at the target capacity. The target capacity can be set by a user through an application running on the electronic device and communicated to the receiver of the charging device. In certain examples, upon detecting that the battery capacity of the electronic device reaches the target capacity, a notification can be sent to a user of the electronic device, notifying completion of the charging. Such notification can be in the form of a text message (or the like) on the electronic device, and/or an indicator on the charging device (e.g., an LED light, or the like).

In another example, the receiver can be configured to receive travel duration data from a moving vehicle in which the charging device is located. For example, travel duration data can be obtained from a flight management system (FMS) on an aircraft, a global positioning system (GPS) on an automobile, etc. Example travel duration data can include estimated time to destination, etc. Based on such travel duration data, the charging device can be configured to (e.g., via the controller 130) automatically determine optimal charging rate profiles, and dynamically adjust or modulate the electrical current fed to the transmitting coil (e.g., slower charging when time to destination is long and vice versa, etc.). Other information, such as battery status and/or usage of the electronic device, elapsed charging time, etc., can also be used regulate the charging rate profiles. For example, based on the difference between the current battery capacity of the electronic device and the predefined target capacity, the charging device can choose different charging rate profiles (e.g., fast charging for a larger difference and slow charging for a smaller difference, etc.).

### Example Advantages

A number of advantages can be achieved via the technologies described herein. For example, the inductive charging device described herein allows dynamic tracking of an electronic device to be charged. A user can place the electronic device at any location on the charging plate of the charging device, and the charging device can automatically align the transmitting coil with the electronic device. Even if the location of the electronic device moves on the charging plate during the charging process, the transmitting coil of the charging device can dynamically track the movement of the electronic device and reestablish alignment to ensure achieving high efficiency of inductive charging. Further, the charging device can have a non-planar charging plate. This can be particularly useful when the charging device is embedded in another article (e.g., table, chair, etc.) that have a contoured or curved surface that is used as a charging surface. Despite the curved charging surface, the technology described herein can still ensure proper alignment between the transmitting coil and the electronic device. Further, the charging device described herein can have multiple coils configured to simultaneously charge multiple electronic devices using a single power source. In addition, feedback control can be used to dynamically adjust the charging rate profile and provide notification to a user when charging is complete.

### Example Computing Systems

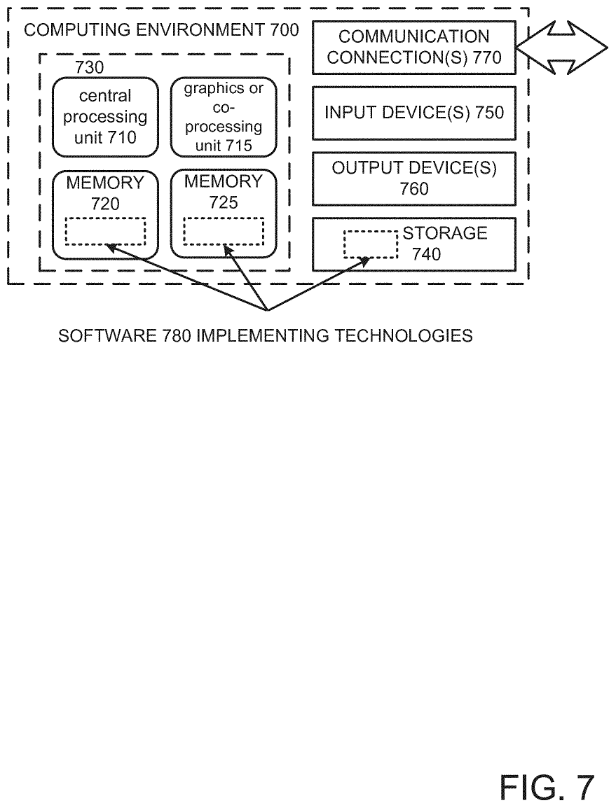

FIG. 7 depicts an example of a suitable computing system 700 in which the described innovations can be implemented. The computing system 700 is not intended to suggest any limitation as to scope of use or functionality of the present disclosure, as the innovations can be implemented in diverse computing systems.

With reference to FIG. 7, the computing system 700 includes one or more processing units 710, 715 and memory 720, 725. In FIG. 7, this basic configuration 730 is included within a dashed line. The processing units 710, 715 can execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 7 shows a central processing unit 710 as well as a graphics processing unit or co-processing unit 715. The tangible memory 720, 725 can be volatile memory (e.g., registers, cache, RAM), non-volatile memory (e.g., ROM, EEPROM, flash memory, etc.), or some combination of the two, accessible by the processing unit(s) 710, 715. The memory 720, 725 can store software 780 implementing one or more innovations described herein, in the form of computer-executable instructions suitable for execution by the processing unit(s) 710, 715.

The computing system 700 can have additional features. For example, the computing system 700 can include storage 740, one or more input devices 750, one or more output devices 760, and one or more communication connections 770, including input devices, output devices, and communication connections for interacting with a user. An interconnection mechanism (not shown) such as a bus, controller, or network can interconnect the components of the computing system 700. Typically, operating system software (not shown) can provide an operating environment for other software executing in the computing system 700, and coordinate activities of the components of the computing system 700.

The tangible storage 740 can be removable or non-removable, and can include magnetic disks, magnetic tapes or cassettes, CD-ROMs, DVDs, or any other medium which can be used to store information in a non-transitory way and which can be accessed within the computing system 700. The storage 740 can store instructions for the software or method (e.g., 200, 300) implementing one or more innovations described herein.

The input device(s) 750 can be an input device such as a keyboard, mouse, pen, or trackball, a voice input device, a scanning device, touch device (e.g., touchpad, display, or the like) or another device that provides input to the computing system 700. The output device(s) 760 can be a display, printer, speaker, CD-writer, or another device that provides output from the computing system 700.

The communication connection(s) 770 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### General Considerations

For purposes of this description, certain aspects, advantages, and novel features of the examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed embodiments require that any one or more specific advantages be present or problems be solved. The technologies from any example can be combined with the technologies described in any one or more of the other examples. In view of the many possible embodiments to which the principles of the disclosed technology may be applied, it should be recognized that the illustrated embodiments are only representative examples and should not be taken as limiting the scope of the disclosed technology.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “connected” generally mean electrically, electromagnetically, and/or physically (e.g., mechanically or chemically) coupled or linked and does not exclude the presence of intermediate elements between the coupled or associated items absent specific contrary language.

Directions and other relative references (e.g., inner, outer, upper, lower, etc.) may be used to facilitate discussion of the drawings and principles herein, but are not intended to be limiting. For example, certain terms may be used such as “inside,” “outside,”, “top,” “bottom,” “interior,” “exterior,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part and the object remains the same. As used herein, “and/or” means “and” or “or”, as well as “and” and “or”.

As used herein, the term “approximately” and “about” means the listed value and any value that is within 20% of the listed value. For example, “about 90 degrees” means any value between about 72 degrees and about 108 degrees, inclusive.

### ADDITIONAL EXAMPLES OF THE DISCLOSED TECHNOLOGY

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. An inductive charging device comprising:

a housing having a compartment and a charging plate covering the compartment, the charging plate having an inner surface and an outer surface; and

a transmitting coil disposed within the compartment;

wherein the transmitting coil is configured to receive an electrical current and generate a magnetic field from the electrical current;

wherein the transmitting coil is configured to move along the inner surface of the charging plate to align with a receiving coil of an electronic device placed on the outer surface of the charging plate, and

wherein the transmitting coil is configured to pivot about at least one axis when moving along a curved portion of the inner surface.

Example 2. The inductive charging device of example 1, wherein the transmitting coil is configured to translate in three dimensions within the compartment.

Example 3. The inductive charging device of any one of examples 1-2, wherein the transmitting coil is configured to rotate about three axes within the compartment.

Example 4. The inductive charging device of any one of examples 1-3, further comprising a sensor configured to detect a location of the electronic device placed on the outer surface of the charging plate.

Example 5. The inductive charging device of any one of examples 1-4, further comprising a flexible arm, wherein a head portion of the flexible arm is configured to receive the transmitting coil and a base portion of the flexible arm is attached to a floor of the compartment.

Example 6. The inductive charging device of example 5, wherein the base portion of the flexible arm is fixedly attached to the floor.

Example 7. The inductive charging device of any one of examples 5-6, further comprising an actuator configured to move the base portion of the flexible arm on the floor so that the transmitting coil is located beneath the electronic device.

Example 8. The inductive charging device of any one of examples 5-7, wherein the flexible arm comprises two or more shafts that are hingedly connected to each other.

Example 9. The inductive charging device of any one of examples 5-8, wherein the flexible arm comprises two or more shafts that are axially slidable relative to each other.

Example 10. The inductive charging device of any one of examples 5-9, wherein a line extending between the head portion and the base portion is configured to remain perpendicular to the floor when moving the transmitting coil along the inner surface of the charging plate.

Example 11. The inductive charging device of any one of examples 1-10, wherein the transmitting coil is one of a plurality of transmitting coils disposed within different regions of the compartment, wherein the plurality of transmitting coils are configured to be electronically coupled to a single power source, wherein each transmitting coil is configured to move along the inner surface of the charging plate within a respective region of the compartment.

Example 12. The inductive charging device of any one of examples 1-11, further comprising a receiver configured to receive a battery status of the electronic device and a controller configured to selectively turning on or off the electrical current by comparing the battery status of the electronic device with a predefined threshold value.

Example 13. The inductive charging device of any one of examples 1-12, further comprising a receiver configured to receive a battery status of the electronic device and travel duration data from a moving vehicle, and a controller configured to modulate the electrical current based on the received battery status of the electronic device and travel duration data.

Example 14. An inductive charging device comprising:

a cover;

a floor;

a chamber enclosed between the cover and the floor;

an arm having a head portion and a base portion;

a transmitting coil received in the head portion and configured to contact or keep a predefined distance from an inner surface of the cover;

a sensor configured to detect an electronic device placed on an outer surface of the cover; and

an actuator configured to move the base portion on the floor in two dimensions so as to align the transmitting coil with the electronic device;

wherein the transmitting coil is configured to receive an electrical current and generate a magnetic field from the electrical current;

wherein at least one portion of the cover is not parallel to the floor such that the chamber has an uneven height measured between the cover and the floor;

wherein the arm is configured to dynamically adjust a vertical distance between the head portion and the base portion to conform to the height of the chamber and maintain contact or keep the predefined distance between the transmitting coil and the inner surface of the cover during movement of the base portion.

Example 15. The inductive charging device of example 14, wherein the at least one portion of the cover has a curved outer surface and a curved inner surface.

Example 16. The inductive charging device of example 15, wherein the transmitting coil is configured to pivot relative to a hinge of the head portion when the transmitting coil moves across the curved inner surface.

Example 17. The inductive charging device of example 16, wherein the transmitting coil is configured to rotate about three axes of the head portion.

Example 18. An inductive charging device comprising:

a housing having a cover and a floor;

an arm extending between the cover and the floor;

a transmitting coil received in a head portion of the arm; and

an actuator configured to move a base portion of the arm on the floor so that the transmitting coil is aligned with an electronic device placed on top of the cover;

wherein the transmitting coil is configured to receive an electrical current and generate a magnetic field from the electrical current;

wherein the transmitting coil maintains contact with or keeps a predefined distance from the cover when moving the base portion of the arm on the floor;

wherein at least a portion of the cover is curved.

Example 19. The inductive charging device of claim 18, wherein the transmitting coil is configured to pivot relative to a hinge of the head portion when the transmitting coil moves across the curved portion of the cover.

Example 20. The inductive charging device of claim 18, wherein the transmitting coil has a planar surface configured to overlap a substantially planar patch on the curved portion of the cover.

Example 21. A method of wirelessly charging an electronic device placed on a curved surface, the method comprising:

detecting a position of the electronic device placed over the curved surface;

moving a transmitting coil underneath the curved surface until the transmitting coil is aligned with a receiving coil the electronic device; and

generating an electrical current in the transmitting coil so as to establish an electromagnetic coupling between the transmitting coil and the receiving coil;

wherein moving the transmitting coil comprises rotating the transmitting coil about at least one axis so that the transmitting coil conforms to a curvature of the curved surface.

Example 22. The method of example 21, wherein moving the transmitting coil comprises rotating the transmitting coil about three axes so as to conform to the curvature of the curved surface.

Example 23. The method of any one of examples 21-22, wherein moving the transmitting coil comprises maintaining contact or keeping a predefined distance between the transmitting coil and an underside of the curved surface.

Example 24. The method of any one of examples 21-23, wherein moving the transmitting coil comprises moving an arm underneath the curved surface, wherein the transmitting coil is received in a head portion of the arm.

Example 25. The method of example 24, wherein moving the transmitting coil comprises moving a base portion of the arm in two dimensions, wherein the base portion of the arm is attached to a floor located under the curved surface.

Example 26. The method of any one of examples 24-25, wherein moving the arm comprises rotating one or more hinged segments of the arm about respective junctions connecting the hinged segments.

Example 27. The method of any one of examples 24-26, wherein moving the arm comprises axially sliding one or more telescopic shafts of the arm.

Example 28. The method of any one of examples 21-27, further comprising receiving a battery status of the electronic device and selectively turning on or off the electrical current by comparing the battery status of the electronic device with a predefined threshold value.

Example 29. The method of example 28, further comprising generating a notification when the battery status of the electronic device reaches the predefined threshold value.

Example 30. The method of any one of examples 21-29, further comprising receiving a battery status of the electronic device and travel duration data from a moving vehicle, and modulating the electrical current based on the received battery status of the electronic device and travel duration data.

Example 31. An inductive charging device comprising:

a housing having a compartment and a charging plate covering the compartment, the charging plate having an inner surface and an outer surface;

a transmitting coil disposed within the compartment;

a sensor configured to detect a first location of an electronic device placed on the outer surface of the charging plate; and

an actuator configured to move the transmitting coil within the compartment so that the transmitting coil is located in a first position on the inner surface of the charging plate, wherein the first position on the inner surface is aligned with the first location of the electronic device;

wherein the sensor is configured to detect the electronic device moves from the first location to a second location on the outer surface of the charging plate;

wherein responsive to detecting the electronic device moves from the first location to the second location, the actuator is configured to move the transmitting coil from the first position to a second position on the inner surface of the charging plate, wherein the second position on the inner surface is aligned with the second location of the electronic device.

Example 32. The inductive charging device of example 31, wherein movement of the transmitting coil from the first position to the second position follows a trace on the inner surface of the charging plate.

Example 33. The inductive charging device of example 32, wherein at least a portion of the trace is curved.

Example 34. The inductive charging device of example 33, wherein the transmitting coil is configured to pivot about one or more axes so that the transmitting coil remains substantially coplanar with or parallel to the inner surface of the charging plate when the transmitting coil moves across the curved portion of the trace.

Example 35. A method of wirelessly charging an electronic device, the method comprising:

detecting a first location of the electronic device placed over a charging surface;

moving a transmitting coil underneath the charging surface until the transmitting coil is moved to a first position aligned with the first location of the electronic device;

detecting the electronic device moves from the first location to a second location over the charging surface; and

responsive to detecting movement of the electronic device, moving the transmitting coil underneath the charging surface to a second position aligned with the second location of the electronic device.

Example 36. The method of example 35, further comprising generating an electrical current in the transmitting coil so as to establish an electromagnetic coupling between the transmitting coil and a receiving coil of the electronic device.

Example 37. The method of any one of examples 35-36, wherein at least a portion of the charging surface between the first location and the second location has a curved shape.

Example 38. The method of any one of examples 36-37, wherein moving the transmitting coil comprises rotating the transmitting coil about at least one axis so that the transmitting coil conforms to the curved shape when moving underneath the portion of the charging surface between the first location and the second location.

The features described herein with regard to any example can be combined with other features described in any one or more of the other examples, unless otherwise stated. For example, any one or more of the features of one delivery apparatus can be combined with any one or more features of another delivery apparatus.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

What is claimed is:

1. An inductive charging device comprising:
a housing having a compartment and a charging plate covering the compartment, the charging plate having an inner surface and an outer surface; and
a transmitting coil disposed within the compartment;
wherein the transmitting coil is configured to receive an electrical current and generate a magnetic field from the electrical current;
wherein the transmitting coil is configured to move along the inner surface of the charging plate to align with a receiving coil of an electronic device placed on the outer surface of the charging plate, and
wherein the transmitting coil is configured to pivot about at least one axis when moving along a curved portion of the inner surface.

2. The inductive charging device of claim 1, wherein the transmitting coil is configured to translate in three dimensions within the compartment.

3. The inductive charging device of claim 1, wherein the transmitting coil is configured to rotate about three axes within the compartment.

4. The inductive charging device of claim 1, further comprising a sensor configured to detect a location of the electronic device placed on the outer surface of the charging plate.

5. The inductive charging device of claim 1, further comprising a flexible arm, wherein a head portion of the flexible arm is configured to receive the transmitting coil and a base portion of the flexible arm is attached to a floor of the compartment.

6. The inductive charging device of claim 5, wherein the base portion of the flexible arm is fixedly attached to the floor.

7. The inductive charging device of claim 5, further comprising an actuator configured to move the base portion of the flexible arm on the floor so that the transmitting coil is located beneath the electronic device.

8. The inductive charging device of claim 5, wherein the flexible arm comprises two or more shafts that are hingedly connected to each other.

9. The inductive charging device of claim 5, wherein the flexible arm comprises two or more shafts that are axially slidable relative to each other.

10. The inductive charging device of claim 5, wherein a line extending between the head portion and the base portion is configured to remain perpendicular to the floor when moving the transmitting coil along the inner surface of the charging plate.

11. The inductive charging device of claim 1, wherein the transmitting coil is one of a plurality of transmitting coils disposed within different regions of the compartment, wherein the plurality of transmitting coils are configured to be electronically coupled to a single power source, wherein each transmitting coil is configured to move along the inner surface of the charging plate within a respective region of the compartment.

12. The inductive charging device of claim 1, further comprising a receiver configured to receive a battery status of the electronic device and a controller configured to selectively turning on or off the electrical current by comparing the battery status of the electronic device with a predefined threshold value.

13. The inductive charging device of claim 1, further comprising a receiver configured to receive a battery status of the electronic device and travel duration data from a moving vehicle, and a controller configured to modulate the electrical current based on the received battery status of the electronic device and travel duration data.

14. An inductive charging device comprising:
a cover;
a floor;
a chamber enclosed between the cover and the floor;
an arm having a head portion and a base portion;
a transmitting coil received in the head portion and configured to contact or keep a predefined distance from an inner surface of the cover;
a sensor configured to detect an electronic device placed on an outer surface of the cover; and
an actuator configured to move the base portion on the floor in two dimensions so as to align the transmitting coil with the electronic device;
wherein the transmitting coil is configured to receive an electrical current and generate a magnetic field from the electrical current;
wherein at least one portion of the cover is not parallel to the floor such that the chamber has an uneven height measured between the cover and the floor;
wherein the arm is configured to dynamically adjust a vertical distance between the head portion and the base portion to conform to the height of the chamber and maintain contact or keep the predefined distance between the transmitting coil and the inner surface of the cover during movement of the base portion.

15. The inductive charging device of claim 14, wherein the at least one portion of the cover has a curved outer surface and a curved inner surface.

16. The inductive charging device of claim 15, wherein the transmitting coil is configured to pivot relative to a hinge of the head portion when the transmitting coil moves across the curved inner surface.

17. The inductive charging device of claim 16, wherein the transmitting coil is configured to rotate about three axes of the head portion.

18. An inductive charging device comprising:
a housing having a cover and a floor;
an arm extending between the cover and the floor;
a transmitting coil received in a head portion of the arm; and
an actuator configured to move a base portion of the arm on the floor so that the transmitting coil is aligned with an electronic device placed on top of the cover;
wherein the transmitting coil is configured to receive an electrical current and generate a magnetic field from the electrical current;
wherein the transmitting coil maintains contact with or keeps a predefined distance from the cover when moving the base portion of the arm on the floor;
wherein at least a portion of the cover is curved.

19. The inductive charging device of claim 18, wherein the transmitting coil is configured to pivot relative to a hinge of the head portion when the transmitting coil moves across the curved portion of the cover.

20. The inductive charging device of claim 18, wherein the transmitting coil has a planar surface configured to overlap a substantially planar patch on the curved portion of the cover.
